(19) United States
(12) Patent Application Publication
(10) Pub. No.: US 2012/0097404 A1
(43) Pub. Date: Apr. 26, 2012

(54) ATM Security System

(75) Inventor: Brett Staines, New South Wales (AU)

(73) Assignee: CHUBB FIRE SAFETY LTD., Ashfield, New South Wales 2131 (AU)

(21) Appl. No.: 13/145,807

(22) PCT Filed: Jan. 22, 2010
(86) PCT No.: PCT/AU2010/000059

§ 371 Date: Oct. 24, 2011

(30) Foreign Application Priority Data
Jan. 23, 2009 (AU) 2009900280
Apr. 20, 2009 (AU) 2009901692

(51) Int. Cl. A62C 3/00; A62C 37/00

(52) U.S. Cl. 169/43; 169/60

(57) ABSTRACT

An automated teller machine security system is provided. The system includes at least one gas detector (100) operatively arranged to detect a flammable gas inside an ATM (20); and at least one fire suppressing agent dispenser (140) arranged so that responsive to detection of said gas, a fire suppressing agent (116) is released within the ATM (20). The system advantageously inhibits ignition of flammable gases within the ATM, and thereby inhibits the ability for thieves to explode an ATM and steal its contents.

### FIELD OF THE INVENTION

The present invention relates generally to security systems for automated teller machines.

### BACKGROUND TO THE INVENTION

Automated teller machines (ATMs) have become well known and widely used around the globe. ATMs allow individuals twenty-four hour access to their bank accounts to conduct various transactions. Such convenience is a significant advantage to financial institution customers. Another advantage is the ability for the institutions to have transactions automated, thereby presenting a cost saving to the institution.

Attempted theft of cash from ATMs has become an increasing problem in recent years. Thieves are not only targeting ATM customers as the cash is withdrawn from the machines, but also physically targeting the machines themselves.

For example, thieves connect chains between the ATM and a motor vehicle, and accelerate the vehicle to thereby force the ATM to dislodge from its surrounding structure. The ATM may then be taken to a remote location where the thieves have time to break into the ATM and extract the cash contained within. This method however results in a relatively slow getaway, and there is a high likelihood of the thief leaving a traceable trail of evidence.

There has been a recent spate of robberies from ATMs by thieves injecting explosive gases, typically hydrocarbons or mixtures such as oxy-acetylene, into the ATM cash vault through the accessible cash withdrawal or deposit slot. The gas is then ignited, exploding open the ATM and distorting the cash vault, thereby allowing direct access to the stored cash. This method has provided a relatively rapid getaway for the thieves since they only need take the cash itself and not the entire ATM.

Authorities have found it difficult to capture the thieves given the explosion and stealing of the cash can be achieved in a very short period of time, and little traceable evidence is produced at the scene. Furthermore, the explosions have become a serious and significant problem to the ATM owners, who not only lose large amounts of cash, but also experience damaged ATMs and often serious structural damage to the surrounding buildings, as well as damaged stock and fittings, and loss of trade whilst repairs are made. There is therefore a need to address these problems.

Australian Innovation Patent No. 2008100802 provides one possible solution to this problem. It discloses a system for detecting hydrocarbon gases, including a controller and two gas sensors. The sensors can be installed in ATMs to detect the injection of gas therein, which if detected, generates a signal to the controller, triggering an alarm to alert authorities of a suspected explosion. One problem with this solution is that it relies on the speed of the authorities when attending the alarmed scene. If the authorities do not attend quickly enough, the explosion will proceed and the thieves may then have sufficient time to steal the cash from within the ATM and make their getaway.

It is therefore an object of the present invention to provide a system for inhibiting the ability of thieves to initiate explosions of ATMs and steal the cash stored therein.

### SUMMARY OF THE INVENTION

Broadly, the present invention teaches the use of a gas detector combined with a fire suppressing device to prevent or at least substantially inhibit an explosion from occurring by the ignition of gases inside an ATM.

In a first aspect, there is provided an ATM security system including: at least one gas detector operatively arranged to detect a flammable gas inside an ATM; and at least one fire suppressing agent dispenser arranged so that responsive to detection of said gas, a fire suppressing agent is released within the ATM.

In a second aspect, there is provided a method of securing the contents of an ATM against theft, the method including the steps of: providing at least one gas detector operatively arranged to detect a flammable gas inside an ATM; providing a fire suppressing agent dispenser; and upon detection by the detector of a flammable gas, actuating the fire suppressing agent dispenser so as to release a fire suppressing agent within the ATM intended to inhibit ignition of said flammable gas.

In a third aspect, there is provided an ATM including: at least one gas detector operatively arranged to detect a flammable gas inside the ATM; and at least one fire suppressing agent dispenser arranged so that responsive to detection of said gas, a fire suppressing agent is released within the ATM.

In a fourth aspect, there is provided a security system for an ATM having a gas detector operatively arranged to detect a flammable gas inside the ATM, the system including: at least one fire suppressing agent dispenser arranged so that responsive to detection of said gas by the gas detector, a fire suppressing agent is released within the ATM.

In a fifth aspect, there is provided a method of securing the contents of an ATM against theft, the ATM having a gas detector operatively arranged to detect a flammable gas inside the ATM, the method including the steps of: providing a fire suppressing agent dispenser; and upon detection by the detector of a flammable gas, actuating the fire suppressing agent dispenser so as to release a fire suppressing agent within the ATM intended to inhibit ignition of said flammable gas.

The term “flammable gas” is intended to cover any gaseous substance that may be used to explode open an enclosure such as an ATM, and is not intended to be limited to any specific compounds, structures or groups.

In one form, there further includes an alarm generating unit for triggering an alarm upon detection by the detector of the flammable gas. This allows authorities to attend the premises as quickly as possible.

In another form, means for disconnecting power to the ATM upon detection by the detector of the flammable gas may also be provided. This inhibits ignition of the gas caused by sparks from the internal electrical equipment, and also protects bystanders who may inadvertently try to use an ATM which has been filled with gas after a failed attack.

The detector will preferably be configured to detect a hydrocarbon gas. Such gases have been used in past robberies of ATMs.

In one form, an aerosol, for example potassium based, may be used as the fire suppressing agent. This has the advantage of being unpressurised, and requires only a small volume dispenser for storage. This allows the agent to be stored within the confines of the cash vault within the ATM, which typically only has minimal free space available.

In another form, carbon dioxide may used as the fire suppressing agent.

Embodiments of the present invention prevent, or at least inhibit to large degree, initiation of an explosion of flammable gas inside an ATM. This inhibits the ability of thieves to compromise the cash vault of the ATM and thereby their ability to retrieve the cash stored therein.

### BRIEF DESCRIPTION OF THE DRAWINGS

An illustrative embodiment according to the present invention will now be described with reference to the accompanying figures, in which:

FIG. 1 is a front elevation view of the exterior a typical wall-mounted ATM;

FIG. 2 is a block diagram showing the interior portions of an ATM from a side elevation in accordance with one embodiment of the present invention;

FIG. 3 is a rear view of the ATM of FIG. 2;

FIG. 4 is a schematic illustration of the embodiment of FIG. 2 in operation;

FIG. 5 shows an enlarged view of the CO₂ cylinder and cabinet of FIG. 4;

FIG. 6 shows an alternative embodiment having an optional second CO₂ cylinder;

FIG. 7 is a block diagram showing the interior portions of an ATM from a side elevation in accordance with a second embodiment of the present invention;

FIG. 8 is a rear view of the ATM of FIG. 7;

FIG. 9 is a schematic illustration of the embodiment of FIG. 7 in operation; and

FIG. 10 is a system diagram in accordance with one embodiment of the present invention, which may be implemented using the embodiments of FIG. 2 or 7.

### DESCRIPTION OF PREFERRED EMBODIMENT

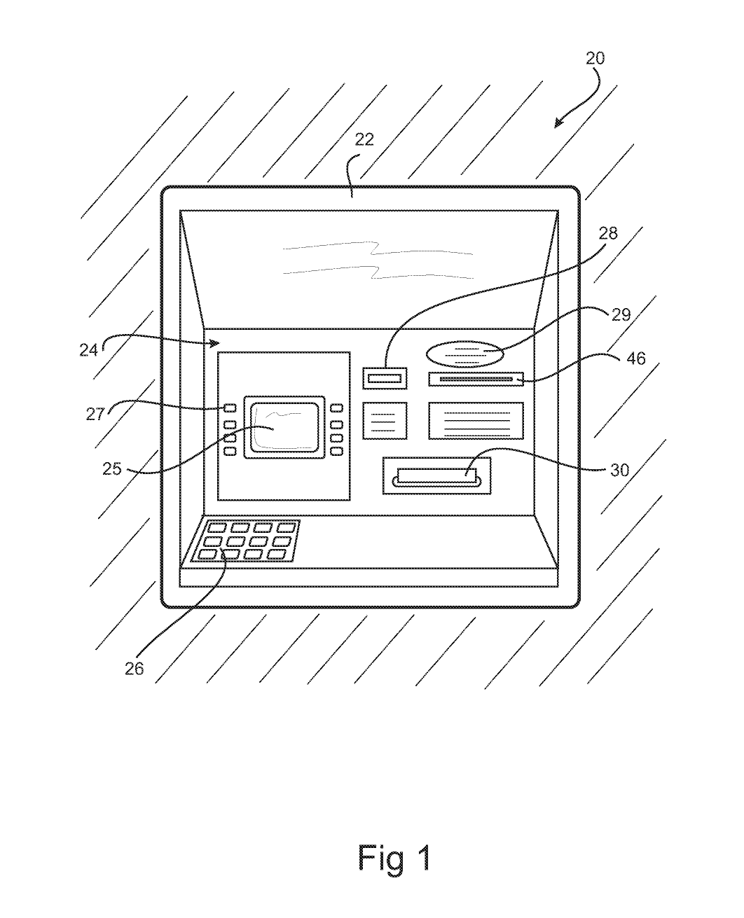

Referring to FIG. 1, there is shown a typical wall-mounted automated teller machine (ATM) 20. It should be noted that the teachings of the present invention are applicable to a wide variety of ATMs and not only wall-mounted units, however for simplicity a wall-mounted unit will be shown in the figures.

ATM 20 includes a housing 22 which encloses an electronic unit 24. The unit 24 includes a screen 25 for displaying information and choices to a user, an alpha/numeric keypad 26, on-screen buttons 27, a card access slot 28, speaker 29 and a cash slot 30 for withdrawal or deposit of cash. Unit 24 is enclosed within a steel lined casing that encloses all of the necessary hardware and software to operate the ATM.

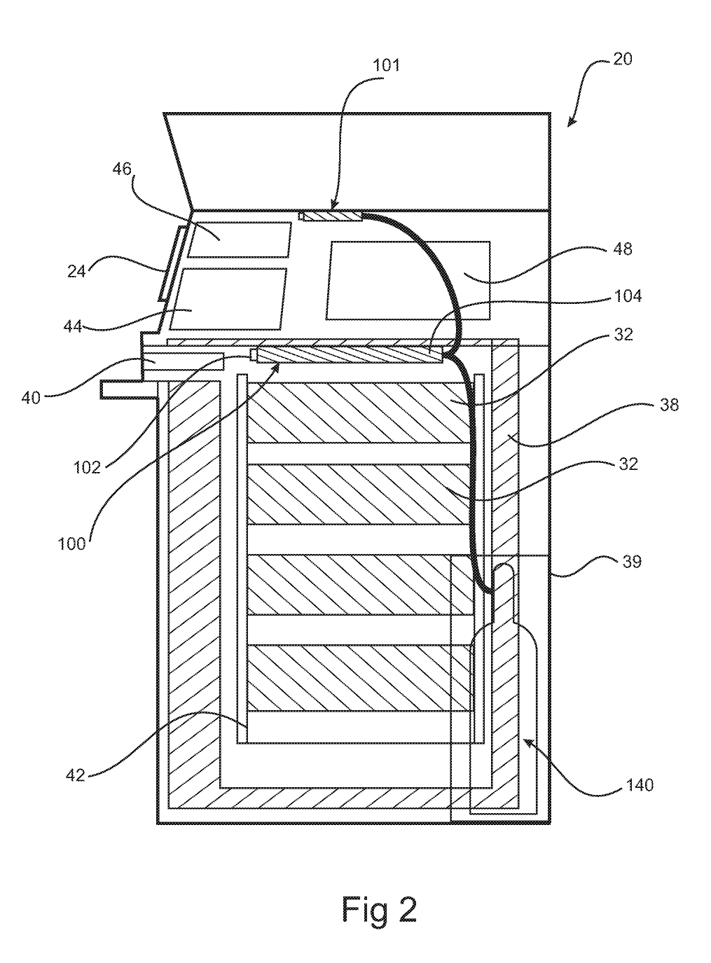

Referring now to the embodiments shown in FIGS. 2 and 3, 7 and 8, ATM 20 is shown in a sectional view having a plurality of cash cassettes 32 stored in the cash vault 38. The cash vault 38 is an enclosure stored inside the outer steel lined casing 39 for securely storing the cash cassettes 32. The cash vault 38 includes a dispensing mechanism 40 connected to the cash slot 30, and a secure locking mechanism (not shown) to ensure controlled access to the contents of the vault 38. Generally the interior of a wall-mounted ATM will be accessible from the rear to allow input of cash cassettes 32, although it may in some embodiments be accessed from the front or side. The cash cassettes 32 may be of any size and shape desirable. Each cash cassette 32 typically dispenses one cash denomination, for example $20 or $50. A cash handling mechanism 42 generally pulls the money from the cassette 32 and delivers it to the cash slot 30. The cash handling mechanism 42 may take many forms, for example a vacuum-type mechanism, and generally includes rails on at least two sides of the cash cassettes 32 for lifting and lowering the cassettes 32 and/or cash stored therein towards the dispensing mechanism 40.

Located behind the unit 24 in the upper portion of the ATM is a card reader 44, receipt printer 46, and processing unit 48.

At least one gas detector is housed inside the ATM to detect flammable gases. In the present embodiments, two gas detectors 100, 101 are used. One gas detector 100 is located inside the cash vault 38, and the second gas detector 101 is located in the upper portion of the ATM near the electrical/processing components. The gas detector 100 located in the cash vault 38 includes at least one sensor head 102 near the opening into the cash vault 38 of the ATM 20, connected to a controller 104, also located within the cash vault 38.

The location of the detector(s) within an ATM may vary depending on the sizes and configurations of the ATM. For example, if there is more than one opening or entrance to the cash vault, additional detectors may be used near those additional openings. An additional detector may also be located towards the base of the cash vault for added security. Additionally, while one detector is preferred in the upper portion of the ATM, in some embodiments this may not be used, and only the detector(s) in within the cash vault being used. In another form, an additional detector may be placed near the cash slot outside of the cash vault, and if there are separate exterior openings for a dispensing cash slot and the cash deposit slot, two detectors may be used. Accordingly, the detectors may take different arrangements in some embodiments, with the main consideration being a location to allow the rapid detection of the presence of a gas.

The most common form of flammable gas used by thieves has been hydrocarbon gas, and specifically an oxy-acetylene mixture. Preferably therefore, the detectors 100, 101 are able to detect hydrocarbon gases, and in particular, a mixture of oxy-acetylene.

An exemplary form of detector 100, 101 which may be used is an SED-A100 AGASdetector manufactured by SEC Eng Systems Pty Ltd and described in Australian Innovation Patent No. 2008100802, the disclosure of which is hereby incorporated in its entirety. Of course, other types of flammable gas detectors as known to a person skilled in the art could also be used.

In the present embodiments, the controller 104 is housed within the cash vault 38 of the ATM, although in other embodiments the controller 104 may be located in other locations within the ATM, or outside of the ATM if desired.

Connected to the controller 104 and at least partially housed within the cash vault 38 is at least one fire suppressing agent dispenser, for dispensing a releasable fire/explosion suppressing agent. The suppressing agent preferably prevents the initiation of a fire or explosion of a flammable gas, although a suppressing agent which minimises the damage caused from an explosion and thereby prevents access to the interior of the cash vault may also be used. In some cases, a suppressing agent which increases the time taken for an explosion to occur may also be used in conjunction with an alarm system (described further below). The suppressing agent may be a chemical, foam or gaseous agent, and which may displace the injected flammable gas, for example an inert gas such as carbon dioxide, argon or nitrogen, or may be an active fire suppressant substance which inerts the atmosphere inside the cash vault, such as an aerosol generator. Many different agents may be used and the present invention is not intended to be limiting in this regard.

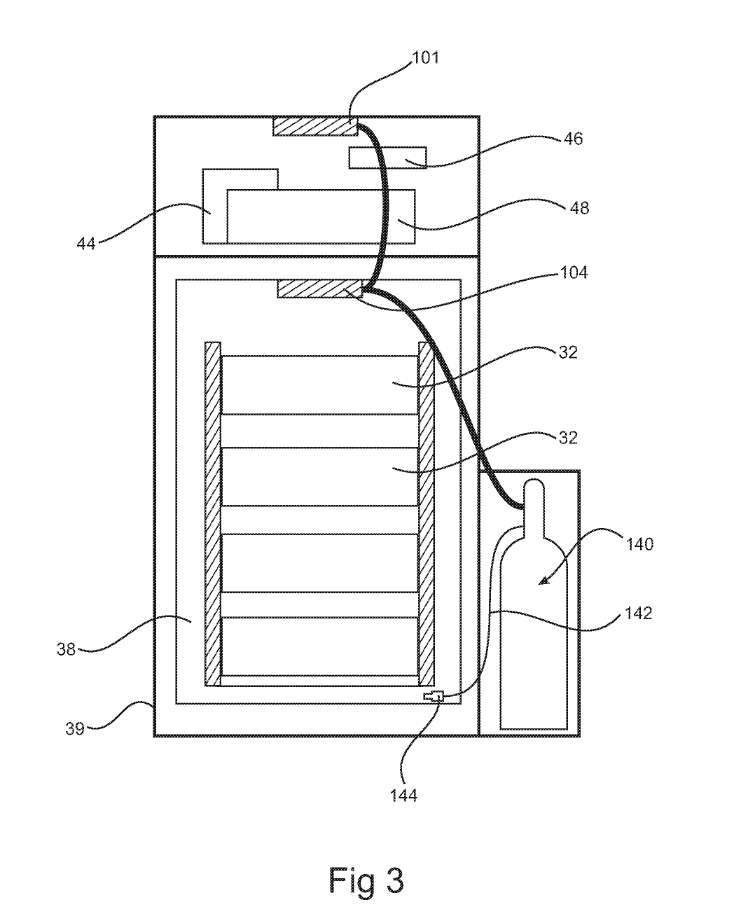

An exemplary suppressing agent which may be used, and is presently preferred, is carbon dioxide, as shown in the embodiment of FIGS. 2 and 3. Carbon dioxide is presently preferred over other insert gases due to its storage efficiency. As CO₂ is stored as a liquid smaller cylinders can be used. Other inert gases are generally stored as gas and would require larger or additional cylinders.

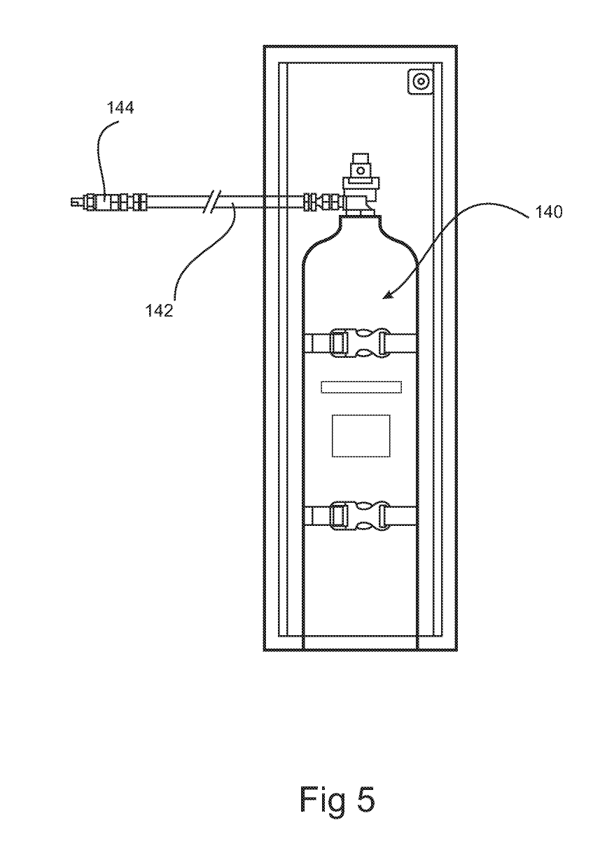

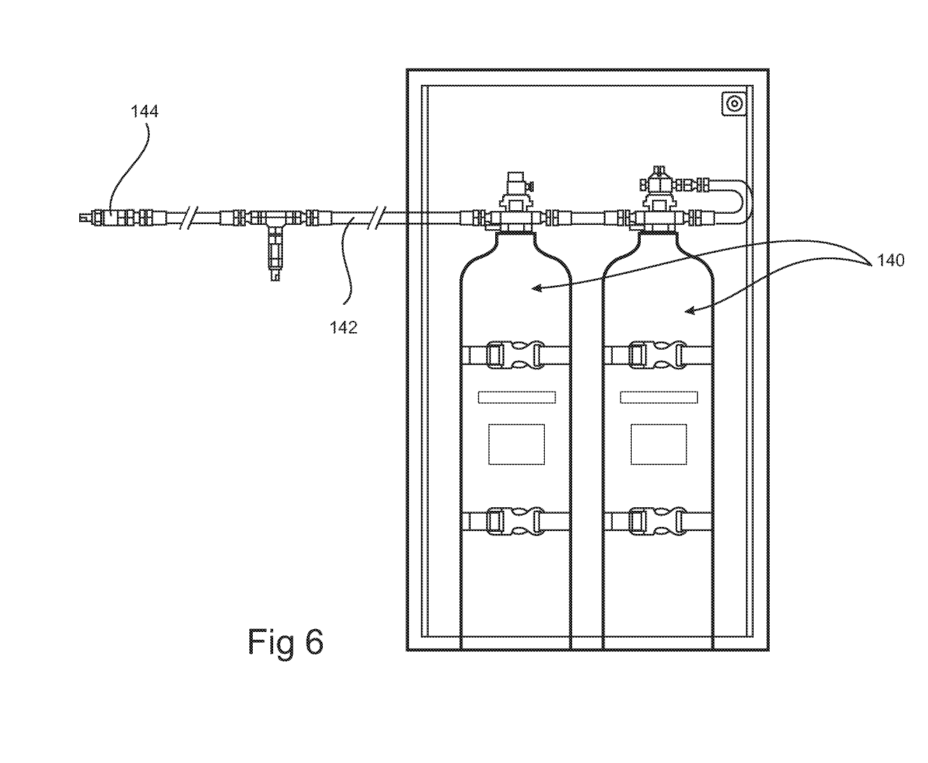

In this embodiment one dispenser 140 is used, taking the form of a cylinder of CO₂ connected to a discharge hose 142 terminating at a discharge nozzle 144 positioned within the cash vault 38. The CO₂ cylinder, due to its size, is housed in a lockable metal cabinet connected to the ATM housing 39, and fitted with a door switch connected to an alarm trigger. In some ATMs the cylinder may be fitted inside the ATM housing, or inside the cash vault, if there is sufficient space. Preferably a 5 kg CO₂ cylinder is used, although other sizes such as a 3.5 kg or 2 kg cylinder may also be used depending upon the length of protection time desired and the amount of storage space available. Various discharge nozzle sizes may be used depending upon the flowrate of the incoming gas and the length of discharge time desired. An exemplary CO₂ cylinder which may be used is shown in greater detail in FIG. 5. For increased protection time, an optional second CO₂ cylinder may also be used, as shown in FIG. 6.

In alternative embodiments, other suppressing agents could also be used. For example, another exemplary suppressing agent is an aerosol, for example potassium based, such as a Stat-X® aerosol as manufactured by Fireaway LLC. The Stat-X® aerosol generator is a self contained extinguishing unit that contains an aerosol forming compound which, during a controlled combustion process within the generator, produces an ultra-fine aerosol extinguishing agent. The units are constructed of stainless steel components, and require no piping, nozzles, or other distribution equipment.

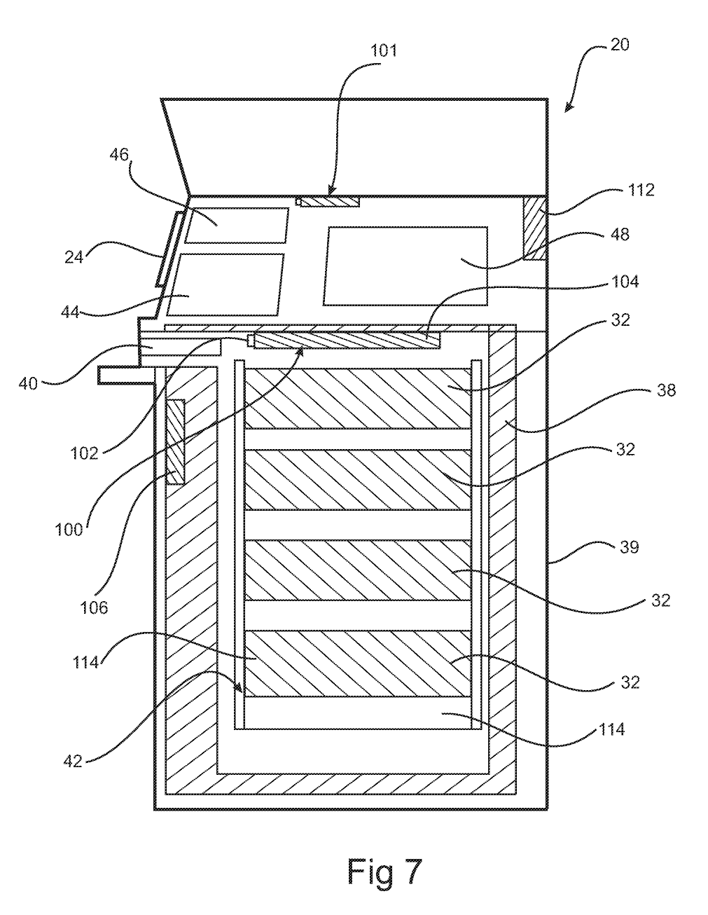

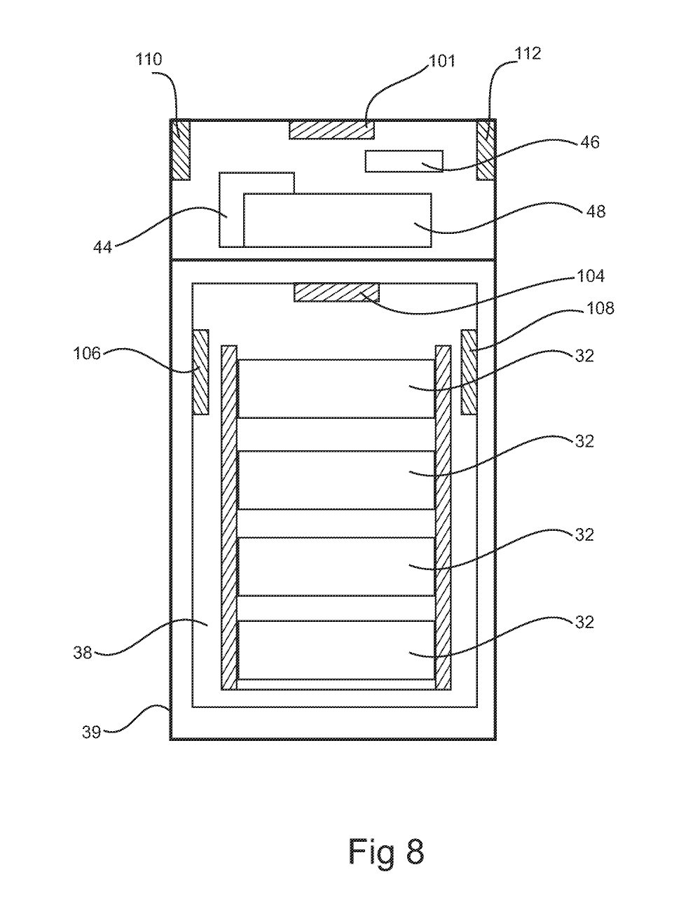

Use of a Stat-X® aerosol generator is illustrated in the embodiment shown in FIGS. 7 and 8. In this embodiment, two dispensers 106, 108 are used, which are located towards the top of the cash vault 38 on either side of the cash cassettes 32. An additional two dispensers 110, 112 are located towards the top of the upper portion of the ATM 20. These additional units may prevent explosions from occurring in the upper portion, thereby preventing significant physical damage to the ATM 20 or the building in which the ATM is located.

The Stat-X® agent has been found to produce only low concentrations of toxic gas within the vault, enhancing safety of security personnel. It also has a low heat output, with the aerosol burning at about 1200 degrees Celsius, exiting the nozzle at about 120 degrees Celcius, and lowering to about 75 degrees Celcius within 600 mm from the nozzle, so it is safe to use inside an ATM, and will not cause any significant damage to the components. The particle size is relatively small, average of about 1-2 microns, with about 85% of compound weight aerosol discharged, and it discharges 30% gas and 70% aerosol, thereby adding to the efficiency and effectiveness of the system. The dispensers are also relatively small in size, as only a small amount of aerosol is required, with a minimum of about 400 grams/cubic metre application density for suitable suppression in a typical sized ATM. The advantage in using an unpressurised agent such as an aerosol generator, and particular the Stat-X® product, is the relatively small dispenser required to contain the compound, which allows the dispenser, and in fact the entire security system, to be housed within the cash vault of the ATM.

The exact location of the dispensers will depend upon the type of fire suppressing agent used, the shape of the cash vault, and the available space. The dispenser may also take any suitable forms of storage container, eg aerosol, as desired, depending upon the suppressing agent used.

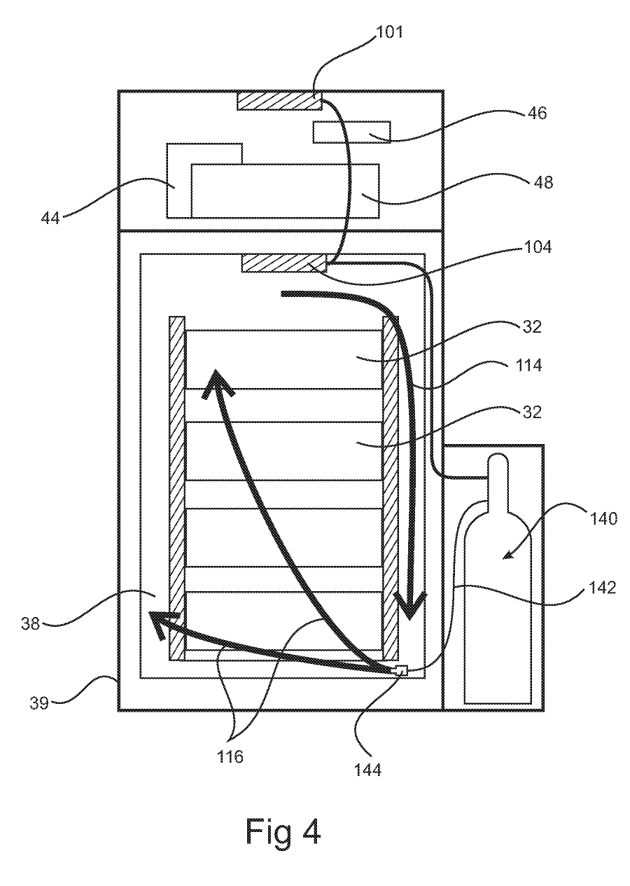

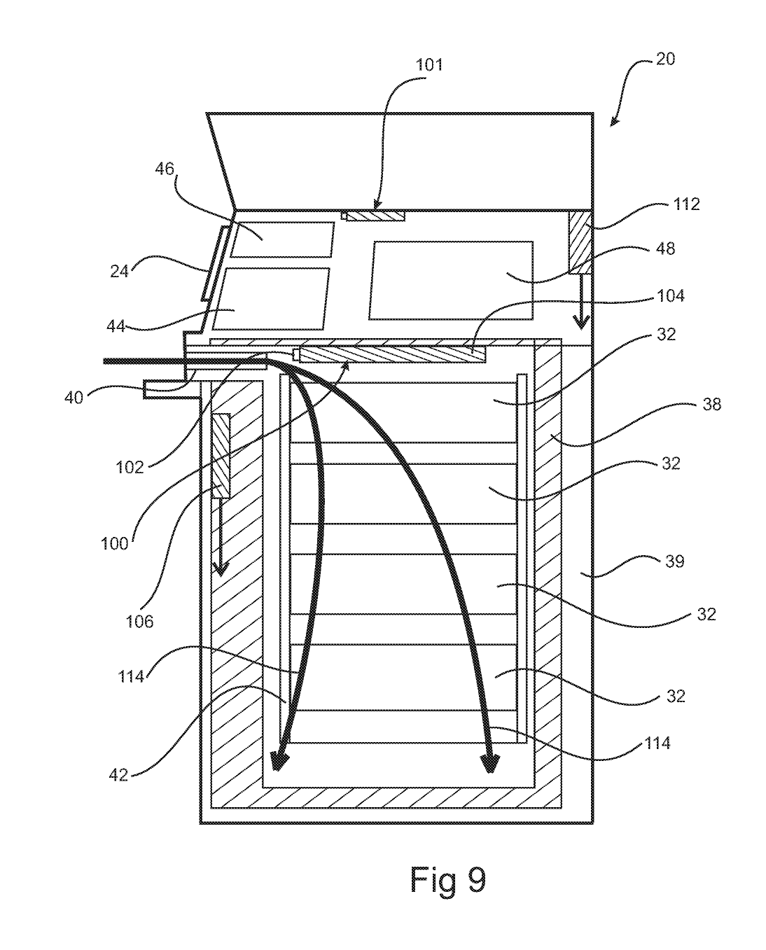

As illustrated in FIGS. 4 and 9, when the sensor 102 detects the presence of a flammable gas within the ATM cash vault as illustrated by the arrows 114, the controller 104 directs the dispensers 106, 108, 110 and 112, or 140, to release the suppressing agent, as indicated by the arrows 116.

Release of the suppressing agent rapidly fills the interior of the cash vault. When the flammable gas is attempted to be ignited by the thieves, the presence of the suppressing agent throughout the vault prevents, or at the very least substantially minimises, explosive detonation of the flammable gas within the cash vault 38. Accordingly, when the thieves attempt to ignite the gas, no explosion will occur, and the cash vault 38 will not be distorted or opened, and the thieves will accordingly be unable to access the cash stored therein.

Once the dispensers have been activated, preferably the suppressing agent remains throughout the cash vault for a sufficient period of time to allow authorities to access the scene, and for the dispensers to be replaced or refilled if necessary, preferably at least 2 to 3 minutes. Using the Stat-X® generator agent per above has been found to remain active within the vault for about one hour in conditions where there is no flow of gas. Using one 5 kg CO₂ cylinder has been found to last about 2.5 minutes, while using two 5 kg CO₂ cylinders about 5 minutes, when a high flowrate of flammable gas is used. The length of time the suppression system remains active will be dependent primarily upon the flowrate of flammable gas injected into the ATM. Secondary factors are how “leaky” the ATM is, and how fast the suppressant “leaks” from the ATM.

If only one dispenser is used, the dispenser will preferably be activated for release substantially immediately after detection of the gas by the detectors. If two or more dispensers are used, each of the dispensers may be activated substantially simultaneously, or alternatively the additional dispensers may be delayed for a further period to cause release some seconds or minutes later. Using several dispensers activated at staggered times (for example 5 seconds later, or 55 seconds later) may increase the suppression time, although this increase in time needs to be balanced against the amount of space available for the additional dispensers. The exact timings for release of the agent will depend upon the flammable gases, suppressing agents and discharge nozzles used.

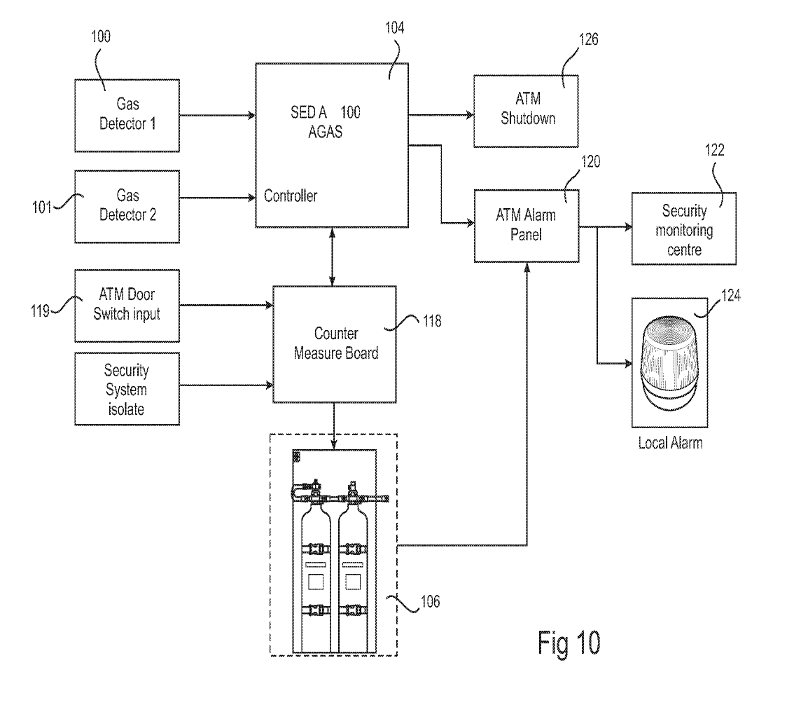

FIG. 10 shows a basic system overview of one embodiment. The gas detectors 100, 101 are connected to the controller 104 through wires, or wirelessly if desired. The controller 104 is connected to a counter measures electronic control board 118 to interface with the fire suppression dispensers 106. The control board 118 provides the functionality required to control the release of the suppression dispensers and other functions required to maintain the integrity of the system, for example monitoring of a switch on the ATM door 119 to prevent tampering with the system, and to de-activate the suppression system during normal ATM service activities if required.

Preferably, upon detecting a gas, the controller 104 will also trigger local and remote alarm signals 120 to notify the authorities of the attempted robbery through an alarm generating unit. Preferably the remote alarm will interface with the ATM's existing alarm system which is typically monitored by a security centre 122. The local alarm 124 will preferably include an audible sound and visual light. The alarm signals 120 may also trigger upon activation of a switch on the ATM door, or the door to the fire suppression dispensers if not stored within the vault.

Additionally, it is preferred that upon detection of a gas, the controller 104 will disconnect the power to the ATM 126 to prevent sparks from the internal electrical equipment igniting the gases, to protect bystanders who may try to use a gas filled ATM after a failed attack. The controller will provide a signal to the existing ATM shutdown arrangement (if applicable), or initiate the shutdown independently, to allow this to occur.

In some embodiments, additional counter-measures may be used and initiated by the controller 104 upon detection of a gas. For example, the controller 104 may also initiate release of a dye to mark the cash, or a dye to mark the thieves themselves. Alternatively or in addition, securing of the cash vault using a blastcover or closing shutter for example could also be initiated.

Advantageously, all the components of the security system may be physically housed with the ATM, or securely connected thereto, and in some forms within the ATM cash vault itself. This provides a higher level of security for the system and reduces the ability for the system to be accessed and disabled by thieves. It also provides for simple installation to existing ATMs. However, it will be appreciated that the present invention could be implemented with some components located outside the ATM itself.

Examples of tests performed using the above embodiments will now be described.

### Example 1

Two cash cassettes and a two 60E Stat-X® generators were positioned inside a 125 Litre enclosure with an opening to simulate the cash slot. An oxy-acetylene mixture (40 psi and 10 psi respectively) was introduced into the enclosure and the first generator was discharged 5 seconds after the oxy-acetylene was introduced. Ten seconds later the second Stat-X® generator was discharged. The mixture was attempted to be ignited 15 seconds after commencing the test and every five seconds thereafter.

Ignition occurred 60 seconds after commencement of test, however no explosion occurred.

### Example 2

Three cash cassettes and two 100E Stat-X® generators were positioned inside a 512 Litre enclosure. An oxy-acetylene mixture (40 psi and 10 psi respectively) was introduced into the enclosure and the generators were discharged 5 seconds after the oxy-acetylene was introduced. Mixture was attempted to be ignited 15 seconds after commencing test and every five seconds thereafter.

Suppression of ignition was achieved for 180 seconds from commencement of test, at which time test was concluded.

### Example 3

Three cash cassettes and two 100E Stat-X® generators were positioned inside a 512 Litre enclosure. An oxy-acetylene mixture was introduced into the enclosure and one generator was discharged 5 seconds after the oxy-acetylene was introduced. The second generator was discharged 55 seconds after the first one. Mixture was attempted to be ignited 15 seconds after commencing test and every five seconds thereafter.

Ignition occurred 170 seconds after commencement of test, however no explosion occurred.

### Example 4

Three cash cassettes and a 3.5 kg CO₂ discharge cylinder were positioned inside a 512 Litre enclosure. An oxy-acetylene mixture was introduced into the enclosure and the CO₂ was discharged via a 1 mm orifice 5 seconds after the oxy-acetylene was introduced. Mixture was attempted to be ignited 15 seconds after commencing test and every five seconds thereafter.

Ignition was suppressed for a period of 5 minutes after which time the test was concluded.

### Example 5

An oxy-acetylene mixture was introduced into an ATM vault having volume of 265 Litres. The oxy-acetylene mixture delivered acetylene and oxygen at 15 psi and 40 psi respectively. A CO₂ cylinder was arranged to deliver CO₂ to a nozzle mounted in the vault via a 500 mm length of 3/16″ hose. The discharge nozzle was mounted at the bottom of the vault and its 180 degree “fan” type discharge directed upwards. Various different nozzle orifices of less than 1 mm were used to provide a range of CO₂ discharge rates and liquid discharge times.

For each test oxy-acetylene was delivered into the cash slot of the ATM vault and after 5 seconds the CO₂ cylinder was discharged. The flow of oxy-acetylene was allowed to continue until near the end of liquid discharge time for the cylinder/nozzle combination being tested was reached. The flow of oxy-acetylene was then stopped and an attempt made to ignite the atmosphere within the ATM.

### Test 1

3.5 kg CO₂ extinguisher was used with a TK1.5 nozzle, which may be sourced from Spraying Systems Co. Pty. Ltd., and 0.5 m discharge hose. Oxy-acetylene was introduced for 100 seconds and no explosion resulted.

### Test 2

2.0 kg CO₂ extinguisher was used with a TK1.5 nozzle and 0.5 m discharge hose. Oxy-acetylene was introduced for 50 seconds and no explosion resulted.

### Test 3

2.0 kg CO₂ extinguisher was used with a TK1.0 nozzle and 0.5 m discharge hose. Oxy-acetylene was introduced for 80 seconds and no explosion resulted.

### Example 6

### Control

Three cash cassettes were positioned inside a 512 Litre enclosure. An oxy-acetylene mixture was introduced into the enclosure for several minutes prior to being ignited. Explosion occurred almost instantaneously and severe damage to enclosure and contents.

The embodiments described above provide an advantageous security system for use within an ATM for preventing, or significantly inhibiting, explosions caused by flammable gases. This provides a solution for combating attempted robberies of ATMs which use explosive gases to open cash vaults within the ATMs. It also prevents serious physical damage to the ATMs, saving on costs for the ATM owners. Furthermore, it allows authorities to be notified at an early stage during the robbery through automatic alarm triggers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

The foregoing discussion is considered as illustrative only of the principles of the invention. Since numerous modifications and changes will readily occur to those skilled in the art, it is not desired to limit the invention to the exact construction and operation shown and described, and accordingly, all suitable modifications and equivalents maybe resorted to, falling within the scope of the invention.

1. An ATM security system including:
at least one gas detector operatively arranged to detect a flammable gas inside an ATM; and
at least one fire suppressing agent dispenser arranged so that responsive to detection of said gas, a fire suppressing agent is released within the ATM.

2. An ATM security system according to claim 1, further including an alarm generating unit for triggering an alarm upon detection by the detector of the flammable gas.

3. An ATM security system according to claim 1 further including means for disconnecting power to the ATM upon detection by the detector of the flammable gas.

4. An ATM security system according to claim 1 wherein the flammable gas includes a hydrocarbon gas.

5. An ATM security system according to claim 1 wherein the fire suppressing agent includes an aerosol, preferably potassium based.

6. An ATM security system according to claim 1, wherein the fire suppressing agent includes carbon dioxide.

7. A method of securing the contents of an ATM against theft, the method including the steps of:
providing at least one gas detector operatively arranged to detect a flammable gas inside an ATM;
providing a fire suppressing agent dispenser;
upon detection by the detector of a flammable gas, actuating the fire suppressing agent dispenser so as to release a fire suppressing agent within the ATM intended to inhibit ignition of said flammable gas.

8. An ATM including:
at least one gas detector operatively arranged to detect a flammable gas inside the ATM; and
at least one fire suppressing agent dispenser arranged so that responsive to detection of said gas, a fire suppressing agent is released within the ATM.

9. An ATM according to claim 8, further including an alarm generating unit for triggering an alarm upon detection by the detector of the flammable gas.

10. An ATM according to claim 8 further including means for disconnecting power to the ATM upon detection by the detector of the flammable gas.

11. An ATM according to claim 8 wherein the flammable gas comprises a hydrocarbon gas.

12. An ATM according to claim 8 wherein the fire suppressing agent includes an aerosol, preferably potassium based.

13. An ATM according to claim 8 wherein the fire suppressing agent includes carbon dioxide.

14. A security system for an ATM having a gas detector operatively arranged to detect a flammable gas inside the ATM, the system including:
at least one fire suppressing agent dispenser arranged so that responsive to detection of said gas by the gas detector, a fire suppressing agent is released within the ATM.

15. A security system according to claim 14, further including an alarm generating unit for triggering an alarm upon detection by the detector of the flammable gas.

16. A security system according to claim 14, further including means for disconnecting power to the ATM upon detection by the detector of the flammable gas.

17. A security system according to claim 14 wherein the flammable gas includes a hydrocarbon gas.

18. A security system according to claim 14 wherein the fire suppressing agent includes an aerosol, preferably potassium based.

19. A security system according to claim 14 wherein the fire suppressing agent includes carbon dioxide.

20. A method of securing the contents of an ATM against theft, the ATM having a gas detector operatively arranged to detect a flammable gas inside the ATM, the method including the steps of:
providing a fire suppressing agent dispenser; and
upon detection by the detector of a flammable gas, actuating the fire suppressing agent dispenser so as to release a fire suppressing agent within the ATM intended to inhibit ignition of said flammable gas.
